(19) United States
(12) Patent Application Publication
(10) Pub. No.: US 2004/0205689 A1
(43) Pub. Date: Oct. 14, 2004

(54) System and method for managing a component-based system

(76) Inventors: Christian C. Ellens, Nepean (CA); Atul Srivastava, Kanata (CA); Thomas A. Lismer, Ottawa (CA)

Correspondence Address: Hunton & Williams, 1900 K Street, N.W., Washington, DC, 20006-1109, US

(21) Appl. No.: 09/749,940

(22) Filed: Dec. 29, 2000

(51) Int. Cl. G06F 17/60; G06F 9/44

(52) U.S. Cl. 717/100; 705/7; 717/120

(57) ABSTRACT

A system and method for managing a component-based system. The system includes at least one application component and a management core. Each of the components is associated with a managed object representation including the management logic of the component. The management core provides a managed object view of each managed object and allows manipulation of management behavior of each managed object through at least one predetermined event policy. The components are a part of a network application. When a predetermined event is reported in association with one of the components, an associated event policy of the at least one predetermined event policy is performed.

The subject matter of this application is related to the subject matter of copending U.S. patent application Ser. No. ______, entitled “System and Method for Managing a Component-Based System,” “Method and System for Integrated Resource Management,” “System and Method for Flexible Network Service Application Components,” and “Method and System for Distributing Services,” respectively, each filed the same day as this application and each being assigned or under obligation of assignment to the same assignee as this application, and each also incorporated by reference.

### FIELD OF THE INVENTION

This invention relates generally to networked computer systems, and more particularly to management of components in networked computer systems.

### BACKGROUND OF THE INVENTION

Software systems generally consist of logic that performs the intended function of the system, as well as logic that allows the system to be monitored and controlled (managed). In the traditional implementation of software systems, there is no deliberate distinction between the functional logic and the management logic.

Thus, management logic embedded in a functional component limits reusability of the functional component, and management logic embedded in a functional component eliminates reusability of the management logic in other components. Management logic defined directly in a programming language and embedded in a functional component is difficult to develop, modify, and maintain. Also, embedded management logic is typically defined to conform to a single, specific management system interface.

### SUMMARY OF THE INVENTION

A system and method for defining the management behavior of a component-based system is described. The system includes at least two components and a management core. Each of the components is associated with a managed object representation. The management core provides a managed object view of each managed object and allows manipulation of management attributes of each managed object through at least one predetermined event policy. The components are a part of an application. When a predetermined event is reported in association with one of the components, an associated event policy of the at least one predetermined event policy is performed.

The present invention describes a system with a distinction between functional logic and management logic, and various unique features of such a system.

These and other objects, features and advantages of the invention will be apparent through the detailed description of the preferred embodiments and the drawings attached hereto. It is also to be understood that both the foregoing general description and the following detailed description are exemplary and explanatory and not restrictive of the scope of the invention.

### BRIEF DESCRIPTION OF THE DRAWINGS

The invention will be described with respect to the accompanying drawings, in which like elements are referenced with like numbers.

FIG. 1 is a block diagram illustrating a simplified view of one embodiment of an architecture for supporting an open programmability environment;

FIG. 2 is a block diagram illustrating a simplified view of one embodiment of a system for managing a component-based system;

FIG. 3 is a block diagram illustrating one embodiment of a configuration of a resource in a system for managing a component-based system;

FIG. 4 is a block diagram illustrating one embodiment of a system for managing a component-based system;

FIG. 5 is diagram of a fully distinguished name tree according to one embodiment of a system for managing a component-based system;

FIG. 6 is a flow diagram illustrating one embodiment of a method for configuring a component in a system for managing a component-based system;

FIG. 7 is a flow diagram illustrating one embodiment of a method for managing a component-based system; and

FIG. 8 is a detailed flow diagram illustrating one embodiment of a method for managing a component-based system.

### DETAILED DESCRIPTION OF THE PREFERRED EMBODIMENTS

The invention is related in one regard to the use of a computer system for managing a component-based system, using computer, network and other resources. According to one embodiment of the invention, the management of the component-based system is provided via the computer system in response to the processor executing one or more sequences of one or more instructions contained in main memory.

Such instructions may be read into main memory from another computer-readable medium, such as the storage device. Execution of the sequences of instructions contained in main memory causes the processor to perform the process steps described herein. One or more processors in a multi-processing arrangement may also be employed to execute the sequences of instructions contained in main memory. In alternative embodiments, hard wired circuitry may be used in place of or in combination with software instructions to implement the invention. Thus, embodiments of the invention are not limited to specific combination of hardware circuitry and software.

The term “computer-readable medium” as used herein refers to any medium that participates in providing instructions to the processor for execution. Such a medium may take many forms, including but not limited to non-volatile media, volatile media, and transmission media. Non-volatile media include dynamic memory, such as main memory. Transmission media include coaxial cables, copper wire and fiber optics, including the wires that comprise the bus. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor for execution. For example, the instructions may initially be borne on a magnetic disk of a remote computer. The remote computer can load the instructions into its dynamic memory and send the instructions over a telephone line using a modem. A modem local to the computer system can receive the data on the telephone line and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by main memory may optionally be stored on a storage device as described herein, either before or after execution by the processor.

The computer system also includes a communication interface coupled to the bus. The communication interface provides a two-way data communication coupling to a network link that is connected to a local or other network. For example, the communication interface may be an integrated service digital network (ISDN) card or a modem to provide a data communication connection to a corresponding type of telephone line. As another example, the communication interface may be a local area network (LAN) card to provide a data communication connection to a compatible LAN. Wireless links also may be implemented. In any such implementation the, communication interface sends and receives electrical, electromagnetic or optical signals that carry digital data streams representing various types of information.

The network link typically provides data communication through one or more networks to other data devices. For example, the network link may provide a connection through local network to a host computer, server or to other data equipment operated by an Internet Service Provider (ISP) or other entity. The ISP in turn provides data communication services through the world wide packet data communication network, now commonly referred to as the “Internet”. The local network and the Internet both use electrical, electromagnetic or optical signals that carry digital data streams. The signals through the various networks and the signals on the network link and through the communication interface, which carry the digital data to and from the computer system, are exemplary forms of carrier waves transporting the information.

The computer system can send messages and receive data, including program code, through the network(s), network link, and the communication interface. In the Internet example, a server might transmit a requested code for an application program through the Internet, ISP, local network and communication interface. In accordance with the invention, one such downloaded application provides for operating and maintaining the integration system described herein. The received code may be executed by the processor as it is received, and/or stored in storage device, or other non-volatile storage for later execution. In this manner, the computer system may obtain application code via a carrier wave or other communications.

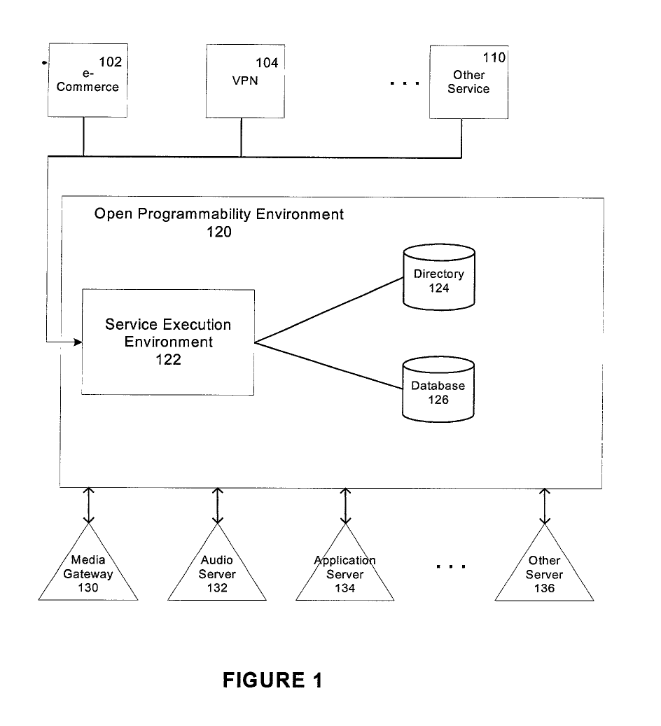

FIG. 1 illustrates an example of an architecture for supporting a system providing an open programmability environment, according to an embodiment of the present invention. An open programmability environment 120 of the present invention provides an environment where, among other things, hardware components do not need to be hardwired to other specific types of components for communication. Instead, various data structures and control logic may be processed in order to establish proper communication with varying and multiple devices. Thus, data of differing types and variations may be received and processed without restructuring or reconfiguring the overall system.

The open programmability environment 120 of the present invention may include hardware, software, communication and other resources. As illustrated in FIG. 1, the open programmability environment 120 may support resources including a service execution environment 122, Directory 124 and Database 126. Other resources may also be included. Generally, a resource may include anything which may be needed for a service to execute successfully. For example, in a telephone network implementation, a resource may include a database, network addresses, switches, and other hardware, software, control logic or other components used to support connections. Other implementations, variations and applications may be used.

A variety of services may execute within the Service Execution Environment of the Open Programmability Environment. These services may include, for example Virtual Private Network (“VPN”) 104, e-Commerce 102, and other services 110, etc. These service may be accessed by a variety of means including web browsers, mobile phones, voice menus, etc.

Back-end processing may occur, for instance, through Media Gateway 130, Audio Server 132, Application Server 134, and other servers 136.

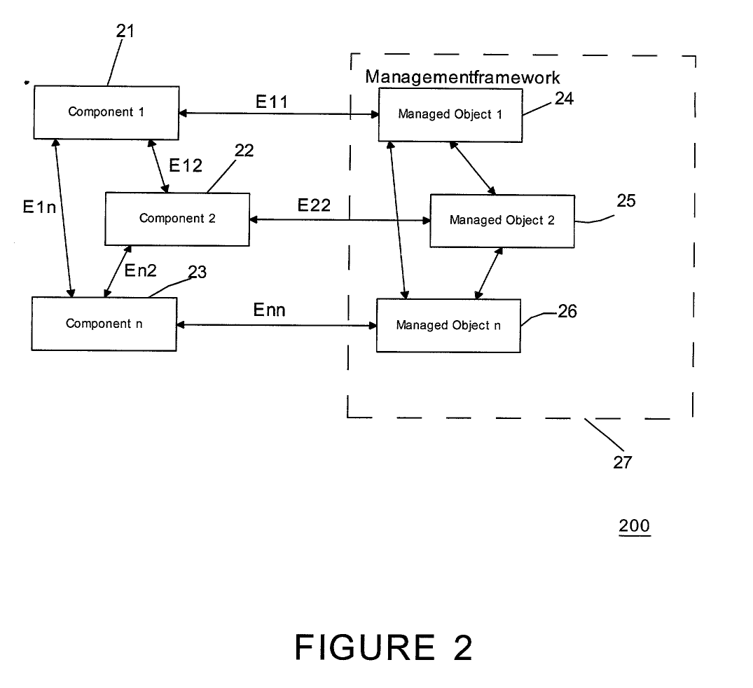

FIG. 2 is a block diagram illustrating a simplified view of one embodiment of a system for managing a component-based system. The system 200 includes components 21-23, management framework 27 including managed objects 24-26 and a managed object observer 28.

System 200 illustrates that an application may be representable by one or more managed objects. Each managed object is associated to exactly one component. Thus, each component 21-23 is associated with one managed object (“MO”) 24-26. Component 121 is associated to MO 1 24. Component 2 22 is associated to MO 2 25. Component n 23 is associated to MO n 26. All MOs 24-26 model each component 21-23 using an identical data model consisting of attributes and events.

Each component 21-23 may communicate with another component 21-23 through a bi-directional set of unidirectional events Exy. Thus, component 121 may communicate with component 2 22 and component n 23 through events E12 and E1n. Component 2 22 may communicate with component n 23 through event En2. In addition, a component 21-23 may communicate with its associated MO 24-26 through a set of events E11, E22, Enn. The specific events in the set will depend on the two interconnected components 21-23 or a component 21-23 and its associated MO 24-26. The MOs 24-26 are interconnected to each other corresponding to the way the components 21-23 are connected to each other.

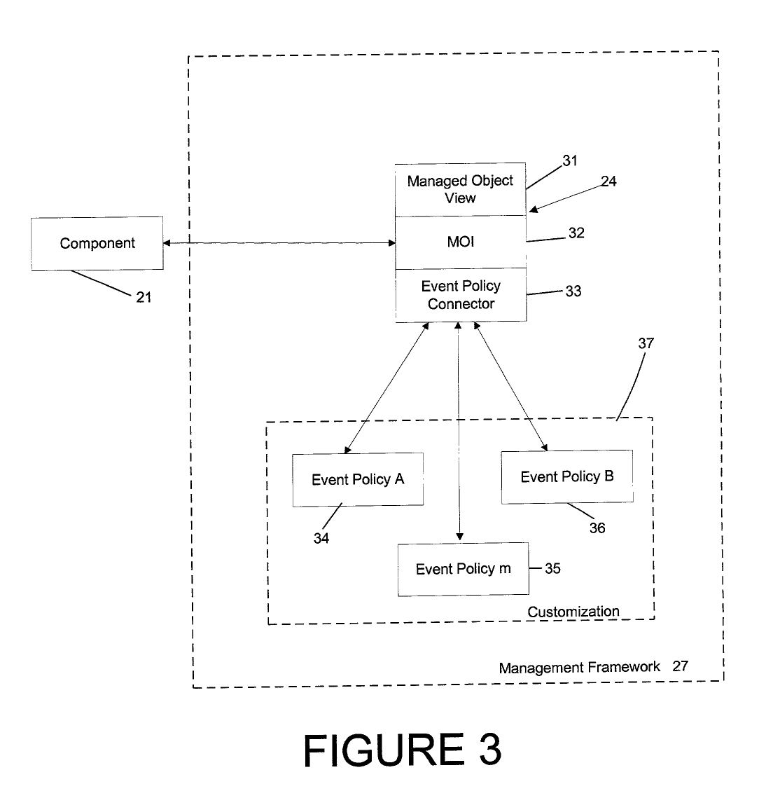

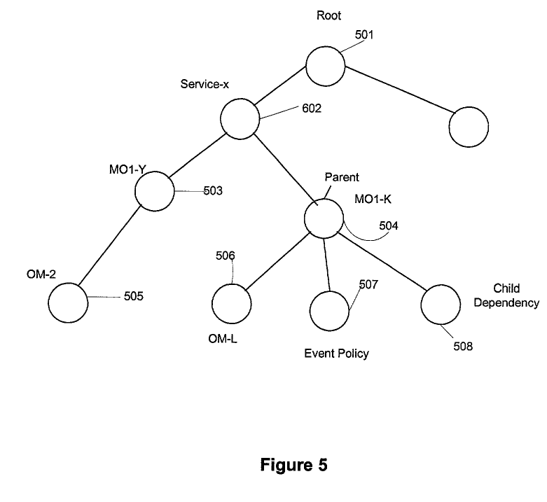

The managed object observer 28 monitors and controls the system as a set of MOs 24-26, each of which possesses an identical model, as will be described below with reference to FIGS. 3 and 5.

The set of MOs 24-26 is contained within management framework 27. The framework 27 provides a set of access mechanisms such that the managed object observer 28 may find and operate on appropriate MOs 24-26.

The common component interface of all the network 100 components 21-23 utilizes an event model as an interconnection mechanism. Each component 21-23 may provide and consume events. All inter-component events have a degree of commonality such that the component interface is programmatically identical. As such, regardless of the event type produced and consumed, any two network 100 components 21-23 may be theoretically jointed, although a given component 21-23 may or may not know how to respond to an arbitrary event Exy. The set of events to and from a given component 21-23 is a function of that component, and each component 21-23 interacts with its MO 24-26 through a potentially unique set of events. However, each MO 24-26 presents a consistent data model to the managed object observer 28.

FIG. 3 is a block diagram illustrating one embodiment of a configuration of a resource in a system for managing a component-based system. The system 300 includes a component 21, a MO representation 24, including a managed object view 31, managed object interpreter 32, and event policy connector 33, and a customization tool 37, including event policies 34-36. Management framework 27 includes the MO representation 24 and event policies 34-36.

Managed object interpreter (“MOI”) 32 provides functionality to translate component specific events into a common managed object data model possessing state, status and alarm attributes. The MOI 32 may communicate with component 21 to translate events into the view represented by managed object view 31. Through event policy connector 33, an event passed to the MOI 32 may be sent to one or more of event policies 34-36 programmed to respond to the event received. Event policies 34-36 may possess states, status and alarms. Thus, MOI 32 aggregates the event policy information across all event policies 34-36 using an aggregation algorithm.

An event policy 34-36 behaves in a deterministic manner in response to events. An event policy type may be created to suit application requirements. For example, a counter may provide a means to count events, a Frequency Meter may measure the frequency of incoming events for comparison to alarm thresholds, etc. Event policies 34-36 respond to a set of events received by the MOI 32, and may send events to the managed object observer 28 and/or the resource 21 upon a state change. Event policies 34-36 may comprise attributes other than states, status or alarms.

Customization tool 37 may consist of an arbitrary set of event policies 34-36 which may be selected from an event policy library through a configuration mechanism, such as a management editor tool.

In an illustrative example, component 21 may provide socket server function, and may be used in a component-based web server application, such as, for example, an application server. Thus, component 21 may be managed to provide a state, status and alarm data, as defined by the managed object model. In addition, managed object observer 28 may be allowed to control the operation of the server.

The socket server may produce events such as Fault Detected Event, for any socket server failures detected and Connection Request Event, for any new socket requests. The socket server may listen and respond to events such as, for example, Go Offline and Go Online. When the socket server hears a Go Offline event, the socket server may close all sessions and not respond to new connection requests. When the socket server hears a Go Online event, the socket server may accept new connection requests.

Event policies that may be associated with the socket server events may include Fault Detected Counter, Connection Request Counter and Administrative State Handler. The Fault Detected Counter may be incremented each time the Fault Detected Event is received by the MOI 32. The managed object observer 28 may view or reset this value.

The Connection Request Counter may be incremented each time a connection request event is received by the MOI 32. The managed object observer may view or set this value.

The Administrative State Handler event policy may allow the managed object observer 28 to choose to lock or unlock the application server. Thus, Administrative State Handler will maintain two states, LOCKED and UNLOCKED. As lock or unlock events arrive from the observer 28, this event policy will change states as appropriate. When a state change occurs, an event may be sent to the MOI 32.

Through the management editor tool, event policies may be registered to listen for specific events from the component 21 or the observer 28. Thus, in application server, for example, as the system starts, the managed object 24 may be in a locked state. The managed object observer 28 may send an unlock event to the managed object 24. The Administrative State Handler may receive this event and change the state to UNLOCKED. The state change may result in an event reported from this event policy to the MOI 32. The MOI 32, upon receiving the event, may notice that the administrative state is unlocked, and send a Go Online event to the component 21 (application server), if no other managed objects are disabled. Thus, application server may start.

In operation, any connections and failures may be counted. The managed object observer 28 may look at the current administrative state and the current counter values at any time. By looking at the counters, users may periodically notice periods of time where faults are rampant. Thus, a customer may disable the application server for a period of time when the fault events are received at an excessive rate.

While the application server is in a disabled state, a critical alarm may be desired to notify the managed object observer 28. A Frequency Meter event policy may be used to provide a critical alarm to notify the managed object observer 28 at the disabled state. The Frequency Meter event policy may be connected to the Fault Detected Event from the component along with Fault Detected Counter event policy.

In operation, the counters may function as before. However, if the frequency of the fault event exceeds a predetermined rate, such as, for example, ten (10) times per second, the Frequency Meter may change to a disabled operational state and produce a critical alarm. As a result, the Frequency Meter may send out an “operational state change,” and “alarm change event” and “log event” to the MOI 32.

Upon receiving the events, the MOI 32 may determine if the operational state is disabled, and the overall alarm level is critical. As a result of the change to the disabled state, the MOI 32 may send a Go Offline event to the component 21, which will terminate operation.

The events, and the log event may be forwarded to the managed object observer 28. When the timer, set for a predetermined amount of time, expires in the frequency meter, the operational state will return to “enabled.” In addition, the alarm may be cleared. The MOI 32 may then send a Go Online event to the component 21.

Thus, a component may be defined in terms of I/O events that may be of interest to the managed objects. As the component 21 is integrated in the system 200, desired event policies may be added. Thus, although the appropriate management behavior in the context of a new application is not known at component design time, the management behavior may be determined at component integration time for a given application. Thus, a component that is generally intended for reuse in numerous systems may have its reusability enhanced since applications specific management behavior need not be implemented in the component until component integration.

Management behavior of the component may also be modified through the addition and removal of event policies to suit the requirements of an application without modifying the component code. Thus, management behavior may be customized by selecting from a predefined set of flexible “event policies” which perform appropriate management functions when events are received from a component 21. Thus, it is possible to manage software components rather than hardware devices. The managed objects 24-26 may be queried or operated on by the managed object observer 28. The configuration driven interpretation mechanism greatly reduces the effort required to translate component specific events to the managed object model.

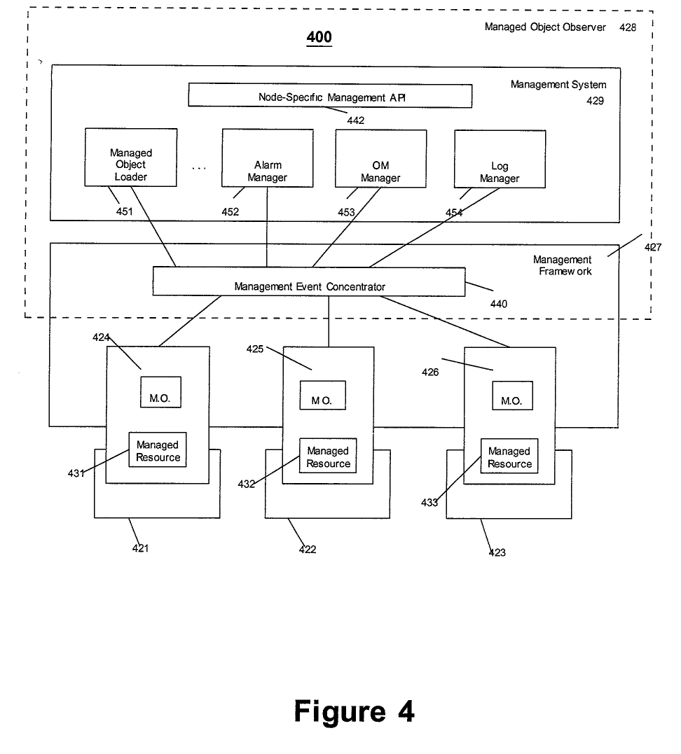

FIG. 4 is a block diagram illustrating one embodiment of a system for managing a component-based system. System 400 includes a management system 429, a management framework 427 and components 421-423. Management system 429 includes node-specific management application programming interface 442 and manager modules 451-454. Management framework 427 includes management event concentrator 440 and managed objects 424-426. Components 421-423 include the managed resource 431-433 portion of components 421-423. Management event concentrator 440 and management system 429 may be part of managed object observer 428.

The management system 429 includes manager modules 451-454, each manager module 451-454 monitoring a specific part of the system. For example, manager module 451 monitors the managed object loader, alarm manager 452 monitors alarms, OM manager 453 monitors measurement and the log manager 454 may log various events.

Management framework 427 is mainly composed of the managed object part 424-426 of application components, as will be described below with reference to FIG. 5, in the system 400. Managed objects 424-426 are a part of an application component and contain logic to perform management behavior. Each managed object 424-426 acts as the management view for an application component and may get most of the management framework layer 427. The management event concentrator 440 is part of the functionality provided by the managed object observer 428. There is only one management event concentrator in system 400. All managed objects 424-426 in the system send management events to the concentrator 440. Thus, the management event concentrator 440 is the single point of contact for all managed objects 424-426 in the system 400.

Each manager module 451-454 within the management system 429 may be responsible for monitoring a specific management aspect of the system, and thus may register with the management event concentrator 440 to listen for a specific event associated with the specific management aspect for which the manager module 451-454 is responsible. For example, the alarm manager 452 may be responsible for monitoring alarms in the system and thus, may register to listen for alarm events.

Each manager module 451-454 may obtain data from managed objects 424-426 through event registration, where events contain data, such as, for example, logs, alarms and state changes, visitation through a fully distinguished name (“FDN”) tree, as described below, and name retrieval, which involves direct FDN access. In the method of receiving data through visitation through the FDN tree, the manager module 451-454 will invoke data collection periodically.

Each manager module 451-454 may call node-specific management API 442 to report management information to a node-specific element management system. The system 400 may be configured with multiple node-specific management API 442.

One possible management API is the Simple Network Management Protocol (SNMP). SNMP may be used by managers to report management information to an element management system such as HP OpenView™, IBM Tivoli™, or any other SNMP-compatible element management system.

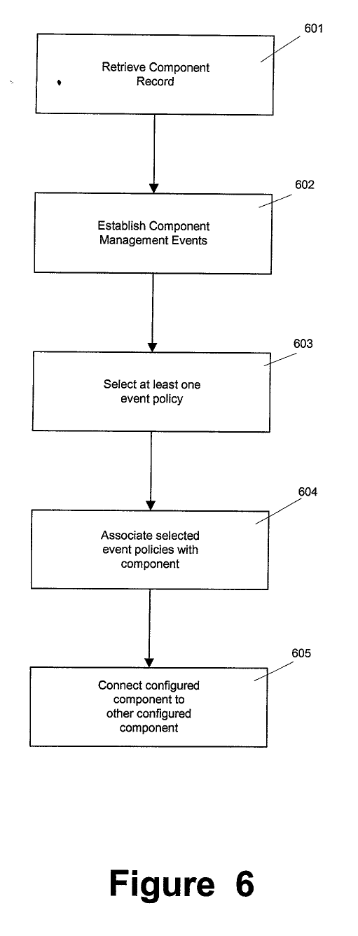

FIG. 6 is diagram of a fully distinguished name tree according to one embodiment of a system for managing a component-based system. Each managed object and its components may be identified by a fully distinguished name (“FDN”). The FDN may be a dot-separated scoped name. For example, the FDN may include an application name 602, the MOI 32 identifier 604, and management component identifier 606 separated by dots. In the FDN tree illustrated, a FDN for OM-L may be expressed as ServiceX.MOI-K.OM-L.

The FDN may be used by the management system 400 for accessing specific management components. The system 400 may map all of the FDNs into a single tree structure 600 to organize managed objects and their component parts. The FDN tree may be used to aggregate management information from child nodes up to parent nodes and all the way up to the root 601, such as in the visitation method discussed above with reference to FIG. 4.

Thus, a manager module may traverse the FDN tree from the child node up to the parent node to aggregate the monitored data. As shown in FIG. 6, in an application, the application node 602 may be a child node to a root node 601. MOI node 603, 604 of managed objects 24-26 of the application may be child nodes to the application node 602. Management component nodes 605-608 may be child nodes to the MOI node 603, 604 of the managed object of which the management components are a part.

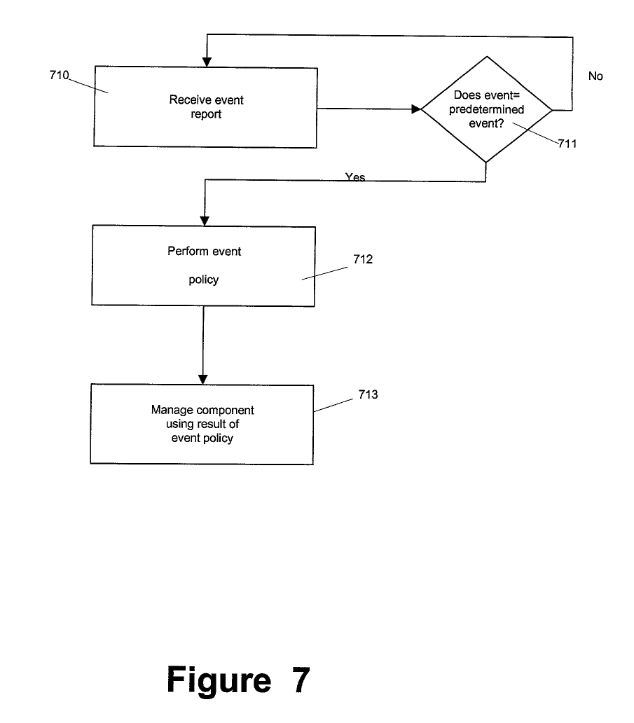

FIG. 7 is a flow diagram illustrating one embodiment of a method for configuring a component in a system for managing a component-based system. At step 701, a component record may be retrieved. At step 702, management events of interest to a component may be established. At step 703, at least one event policy may be selected for each established component management event. At step 704, selected event policies may be associated with component events. At step 705, the configured component 21 may be connected to at least one other configured component 21.

At step 701, a component record may be retrieved from a component record storage area. At step 702, events of interest to the retrieved component may be established. The events of interest may include events that provide an indication that management activities may be required such as, for example, Fault Detected Event, as described in the example above, with respect to application server.

At step 703, at least one event policy may be selected for each established management component event. For example, if Fault Detected Event is chosen as a component event of interest, a Fault Detected Counter may be an event policy selected to count the faults detected.

At step 704, the component events established are each associated to each event policy selected for the event to configure the component. Thus, if the event of interest occurs within component 21, the event policy will be triggered to perform a management activity. The component event association to event policies may be performed by a management editing tool. The events chosen for observation and the event policies associated to the events chosen may be edited as application or system requirements change.

At step 705, the configured component 21 may be connected or associated to at least one other configured component 21 to create a network application. The network application may be stored in an application model storage area to allow access by the system for managing a component based system.

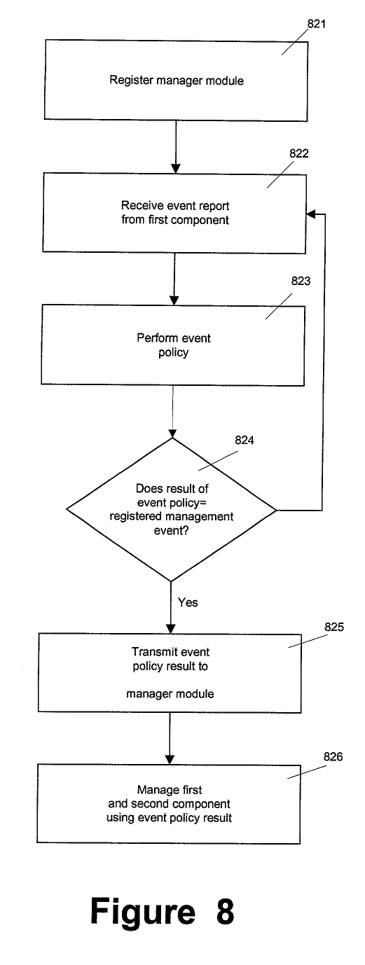

FIG. 8 is a flow diagram illustrating one embodiment of a method for managing a component-based system. At step 810, an event report is received. At step 811, the management system checks to see if the events received matches a predetermined event. If the event received does match a predetermined event, an associated event policy is performed by the management system at step 812. If the event does not match a predetermined event, the management system returns to step 810 to receive another event report. At step 813, component 21 is managed using a result of the event policy performed at step 812.

At step 810, a report of an event may be received from at least one component. The event may be any type of event occurring in the component. At step 811, the event received may be compared to events stored as being of interest to the management of the component in its current application.

If the event received matches a stored event, an event policy associated with the stored event may be performed at step 812. The event policy may include any event policy that may be used to manage the component and its application. The event policy may be chosen from a library of available event policies at the time the component is configured and integrated into the component-based system, as described above. The management event policy performed may include manipulating management attributes of the component such as manipulating an indicator of ability to provide service (e.g., enabled or disabled), usage of the component 21 (e.g., idle, active, busy), degree to which the component 21 is allowed to provide service (e.g., unlocked, shutting down, locked), status, or alarm attributes.

For example, the component event may be a fault, and the event policy performed may be a fault management event policy updating the status of the component or the component event may be an alarm and the event policy performed may be an alarm reporting event policy.

If the event does not match a stored event, the system may return to step 810 to receive another event report.

At step 813, the component 21 may be managed using a result of the event policy. In the example of a Fault Detected Event and a Fault Detected Counter event policy, the frequency of the faults detects counted by the fault detect counter may be used to determine to disable the component 21 or produce an alarm or both. Managing the component may also include checking the status of a dependent component. For example, if the disabled state of a first component is received as a result of an event policy that disables the first component, a management application, such as a Dependency Management application, may need to be performed. When the Dependency Management application is performed, a second component that is normally dependent on the first component may have its status changed to “degraded” through an event policy performed in the second component. If the second component is critically dependent on the first component, the second component may also be disabled until the first component is again enabled. The event policies triggering a Dependency Management application may include one or more of a state change, a status change, an alarm report, a startup or a shutdown of the first component. The event policies performed on the second component 21 may include one or more of a state change, a status change, an alarm report, a startup, a shutdown or a rerouting of the dependency of the second component, such as by going to a backup hard drive for a database look up application when the primary hard drive is disabled or shutdown.

FIG. 9 is a detailed flow diagram illustrating one embodiment of a method for managing a component-based system 400. At step 921, a manager module is registered by the management system. At step 922, an event report is received from a first component 21. At step 923, an event policy is performed. At step 924, the management system checks to see if the result of the event policy matches a registered management event. If the result of the event policy does not match a registered management event, the management system returns to step 922 to receive another event report. If the result of the event policy does match a registered management event, at step 925, the event policy result is transmitted to a manager module 451-454. At step 926, the first and second component 21-23 are managed using the event policy results.

At step 921, at least one manager module 451-454 may be registered to monitor a management event for the network, as described above with respect to FIG. 4. At step 922, an event report may be received from a first component 21. The receiving the event report may include receiving the event report from a context-specific logic through a context-free management logic of the component 21.

At step 923, an event policy associated with the received event may be performed if the event received matches an event in a management event storage area, indicating that the event is of interest to the management of the component 21.

At step 924, the result of the event policy performed at step 923 may be compared to stored registered management events. If the result of the event policy matches a stored management event, the result of the event policy may be transmitted to the manager module registered to monitor the management event at step 925.

If the result of the event policy does not match a stored management event, the method returns to step 922 to receive another event report.

At step 926, the result of the event policy performed at step 923 may be used to manage the first component 21 and a second component 22 associated with the first component. The second component 22 may be a part of an application of which the first component 21 is a part

The method may also include any or all of the steps of connecting to a first managed object 24 associated with the first component 21 and connecting to a second managed object associated with the second component 22, associating at least one event policy with at least one event for each of the components 21, 22, starting up the first component 21 through the first managed object 24, starting up the second component 22 through the second managed object 25.

Other embodiments, uses and advantages of the invention will be apparent to those skilled in the art from consideration of the specification and practice of the invention disclosed herein. The specification should be considered exemplary only, and the scope of the invention is accordingly intended to be limited only to the following claims.

What is claimed is:

1. A system for managing a component-based system, comprising:
one or more application components, each of the components associated with a managed object representation comprising management logic of the component; and
a management core providing a managed object view of each managed object and allowing manipulation of management attributes of each managed object through at least one predetermined event policy
wherein when a predetermined event is reported in association with one of the components, an associated event policy of the at least one predetermined event policy is performed.

2. The system of claim 1 further comprising a management framework including the managed objects and supporting a variety of access mechanisms to the managed object.

3. The system of claim 2 further comprising at least one management application associated with the management framework performing management functions on the managed object wherein performance of one of the at least one predetermined event policy causes performance of a predetermined one of the at least one management application.

4. The system of claim 3 wherein the management attributes comprises component dependency and the at least one management application comprises a dependency management application, the dependency management application causing performance of a second management event policy on a second component dependent on a first component if a first management event policy is performed on the first component.

5. The system of claim 4 wherein the first management event policy comprises at least one of: a state change, a status change and an alarm report of the first component.

6. The system of claim 1 wherein the management attributes comprise at least one of: ability to provide service, usage of the component, degree to which the component is allowed to provide service, status and alarm attributes.

7. The system of claim 1 wherein the predetermined event is a fault and the associated event policy is a fault management event policy.

8. The system of claim 7 wherein the fault management event policy comprises current status maintenance.

9. The system of claim 1 wherein the predetermined event is an alarm and the associated event policy is an alarm reporting function.

10. The system of claim 1 wherein the management attributes comprise component dependency status.

11. The system of claim 1 further comprising at least one metric associated to the managed object wherein the at least one metric may be used to measure performance attributes of the component.

12. The system of claim 1 wherein the at least one predetermined event and the associated event policy may be edited.

13. The system of claim 1 wherein the at least one predetermined event and the associated event policy are configured into the managed object view of the component.

14. The system of claim 13 wherein the at least one predetermined event and the associated event policy are configured using a management editor tool.

15. The system of claim 1 wherein the management attributes comprise state and component dependency wherein a predetermined dependency event policy is performed on a first component based on the state of a second component upon which the first component is dependent.

16. The system of claim 15 wherein the dependency event policy comprises startup of the first component.

17. The system of claim 15 wherein the dependency event policy comprises shutdown of the first component.

18. The system of claim 15 wherein the dependency event policy comprises rerouting the dependency of the first component.

19. The system of claim 1 wherein the system is a telephony network.

20. The system of claim 1 wherein the system is a hybrid network.

21. A system for managing a component-based system, comprising:
one or more application components, each of the components associated with a managed object representation comprising management logic of the component; and
a management framework including the managed objects and a management event concentrator and allowing manipulation of management attributes of each managed object through at least one predetermined event policy.

22. The system of claim 21 wherein the managed object comprises a managed object interpreter and at least one management component, each management component including one of the management attributes.

23. The system of claim 21 wherein each managed object in the system sends management events to the management event concentrator.

24. The system of claim 23 further comprising at least one manager module coupled to the management event concentrator wherein each manager module monitors a specific management attribute for the system.

25. The system of claim 24 further comprising a management layer including the at least one manager module and at least one node specific management application programming interface (“API”) wherein each manager module reports management information to a node specific element management system through the node specific API.

26. The system of claim 21 wherein each managed object and each management component comprise an identifier to allow the management system to access specific management components.

27. The system of claim 26 wherein the identifiers are mapped into a single tree structure.

28. A method of managing a component-based system comprising:
retrieving a record associated with a component;
establishing component events for managing the component;
selecting at least one event policy from a event policies storage area; and
associating at least one component event to each selected event policy to configure the component creating a network application, which may include additional configured components,
wherein the associated event policy is performed in the component based system if the at least one component event occurs.

29. The method of claim 28 further comprising storing the network application in an application model storage area.

30. The method of claim 28 wherein associating the component event to the selected event policy comprises associating the component event to the selected event policy using a management editor tool.

31. The method of claim 28 further comprising editing the at least one event.

32. The method of claim 28 further comprising editing the associated event policy.

33. The method of claim 28 further comprising associating the at least one component to a managed object representation in a management framework wherein the managed object representation is associated with the associated event policy.

34. The method of claim 28 further comprising associating the component with a management framework coupled to at least one management application performing a management functions wherein performance of the associated event policy causes performance of a predetermined one of the at least one management application.

35. The method of claim 28 further comprising manipulating management attributes of the component through the associated event policy wherein the management attributes comprise at least one of: ability to provide service, usage of the component, degree to which the component is allowed to provide service, status and alarm attributes.

36. The method of claim 28 wherein the event policy comprises one of: a state change, a status change and an alarm report.

37. A system for managing a component-based system comprising:
means for retrieving a record associated with a component;
means for establishing component events for managing the component;
means for selecting at least one event policy from a event policies storage area; and
means for associating at least one component event to each selected event policy to configure the component creating a network application, which may include additional configured components,
means for wherein the associated event policy is performed in the component based system if the at least one component event occurs.

38. A method of managing a component-based system, comprising:
a) receiving a report of an event from at least one component;
b) performing a management event policy associated with the event if the event matches an event stored in a managed object representation of the component; and
c) managing the at least one component using the result of the management event policy performed.

39. The method of claim 38 wherein performing the management event policy comprises manipulating management attributes of the component.

40. The method of claim 39 wherein manipulating the management attributes of the component comprises manipulating indicators of at least one of ability to provide service, usage of the component, degree to which the component is allowed to provide service, status and alarm attributes.

41. The method of claim 38 wherein managing the at least one component comprises performing a management application if the result of the management event policy performed matches a predetermined management event policy result.

42. The method of claim 41 wherein the management event policy is a first management event policy and the component is a first component, and performing the management application comprises performing a second management event policy on a second component if the first management event policy is performed on the first component upon which the second component is dependent.

43. The method of claim 38 wherein the first management policy comprises performing at least one of a state change, a status change, an alarm report, a startup and a shutdown of the first component.

44. The method of claim 38 wherein the second management event policy comprises performing one of a state change, a status change, an alarm report, a startup, a shutdown and rerouting the dependency of the second component.

45. The method of claim 38 wherein managing the at least one component comprises storing the result of the component event policy performed in a management aggregator and performing a management event policy when the number of component event policy results stored in the management aggregator reaches a predetermined value.

46. The method of claim 38 wherein the event comprises a fault and performing the associated management event policy comprises performing a fault management event policy.

47. The method of claim 46 wherein performing a fault management event policy comprises updating a status of the component.

48. The method of claim 38 wherein the event comprises an alarm and performing the event policy comprises reporting the alarm.

49. The method of claim 38 further comprising measuring performance attributes of the component using the result of the management event policy.

50. A system for managing a component-based system, comprising:
means for receiving a report of an event from at least one component;
means for performing a management event policy associated with the event if the event matches an event stored in a managed object representation of the component; and
means for managing the at least one component using the result of the management event policy performed.

51. A method of managing a component based system comprising:
registering at least one manager module to monitor a management event for the network;
receiving an event report from a first component;
performing an event policy associated with the event if the event matches a predetermined event policy triggering event;
transmitting a result of the event policy performance to the at least one manager module if the result of the event policy performance matches the management event monitored by the at least one manager module; and
using the result of the event policy performance to manage at least the first component and a second component associated with the first component.

52. The method of claim 51 further comprising:
connecting to a first managed object associated with the first component and a second managed object associated with the second component;
associating at least one event policy with at least one event of each of the first component and the second component; and
starting up the first component through the first managed object and the second component through the second managed object.

53. The method of claim 51 wherein receiving the event report comprises receiving the event report from a context-specific logic through a context-free management logic of the component.

54. A system for managing a component based system comprising:
means for registering at least one manager module to monitor a management event for the network;
means for receiving an event report from a first component;
means for performing an event policy associated with the event if the event matches a predetermined event policy triggering event;
means for transmitting a result of the event policy performance to the at least one manager module if the result of the event policy performance matches the management event monitored by the at least one manager module; and
means for using the result of the event policy performance to manage at least the first component and a second component associated with the first component.

55. A computer readable medium, the computer readable medium storing computer readable code executable to perform a method for managing a component-based system comprising:
retrieving a record associated with a component;
establishing component events for managing the component;
selecting at least one event policy from a event policies storage area; and
associating at least one component event to each selected event policy to configure the component creating a network application, which may include additional configured components,
wherein the associated event policy is performed in the component based system if the at least one component event occurs.

56. A computer readable medium, the computer readable medium storing computer readable code executable to perform a method for managing a component-based system, including at least one telephony resource, comprising:
a) receiving a report of an event from at least one component;
b) performing a management event policy associated with the event if the event matches a stored event; and
c) managing the at least one component using the result of the management event policy performed.

57. A computer readable medium, the computer readable medium storing computer readable code executable to perform a method for managing a component-based system comprising:
registering at least one manager module to monitor a management event for the network;
receiving an event report from a first component;
performing an event policy associated with the event if the event matches a predetermined event policy triggering event;
transmitting a result of the event policy performance to the at least one manager module if the result of the event policy performance matches the management event monitored by the at least one manager module; and
using the result of the event policy performance to manage at least the first component and a second component associated with the first component.
